(19) United States
(12) Patent Application Publication
(10) Pub. No.: US 2024/0273717 A1
(43) Pub. Date: Aug. 15, 2024

(54) METHODS AND SYSTEMS FOR USE IN CLASSIFICATION OF PLANTS IN GROWING SPACES

(71) Applicant: Monsanto Technology LLC, Saint Louis, MO (US)

(72) Inventors: Tanmay AGARWAL, Stanford, CA (US); Joshua DEAN, Eagan, MN (US); Michael Joseph FRANK, Troy, MO (US); Balathasan GIRITHARAN, Chesterfield, MO (US); Patricio S. LA ROSA ARAYA, Saint Louis, MO (US); Andrew MUEHLFELD, Apex, NC (US); Alexander Harry SHERIDAN, Saint Charles, MO (US); Zachary Kevin STRAATMANN, Washington, MO (US); Dimitris ZERMAS, Golden Valley, MN (US)

(21) Appl. No.: 18/439,588

(22) Filed: Feb. 12, 2024

(30) Foreign Application Priority Data
Feb. 13, 2023 (GR) 20230100111

(51) Int. Cl. G06T 7/00; G06V 10/764; G06V 10/82; G06V 20/10

(52) U.S. Cl. CPC G06T 7/0012; G06V 10/764; G06V 10/82; G06V 20/188; G06T 2207/20021; G06T 2207/20081; G06T 2207/20084; G06T 2207/20132; G06T 2207/30188

(57) ABSTRACT

Systems and methods are provided for identifying rogue plants in an agricultural field. One example computer-implemented system includes accessing data specific to an agricultural field, where the data includes an image of the field captured, by at least one capture device, during a particular growth stage of a crop in the field. The method also includes applying a trained classifier model to the sub-images from the image and classifying, using the trained classifier model, each of the multiple plants included in the sub-images as a rogue plant or as not a rogue plant.

### CROSS-REFERENCE TO RELATED APPLICATION

This application claims the benefit of, and priority to, Greek patent application Ser. No. 20/230,100111, filed on Feb. 13, 2023. The entire disclosure of the above application is incorporated herein by reference.

### FIELD

The present disclosure generally relates to methods and systems for use in classification of plants in growing spaces, to identify certain of the plants (e.g., rogue plants within a crop of plants, etc.) for striking at (e.g., removal from, destruction at, etc.) the growing spaces, for example, to avoid contamination of a crop of plants harvested from the growing spaces with the other certain plants.

### BACKGROUND

This section provides background information related to the present disclosure which is not necessarily prior art.

Crops are planted, grown, and harvested in various different regions. In connection therewith, the planting and harvesting of the crops may be related to building a stock of a specific seed, which includes specific trait stacks, phenotypes, etc. The seeds, from the regions, may then be commercialized, whereby the seeds are sold, after harvest, as supply to growers to be planted to grow subsequent crops.

### SUMMARY

This section provides a general summary of the disclosure and is not a comprehensive disclosure of its full scope or all of its features.

Example embodiments of the present disclosure generally relate to methods for use in identifying rogue plants in growing spaces.

In one example embodiment, such a method generally includes: (a) accessing, by a computing device, data specific to an agricultural field, the data including an image of the field captured, by at least one capture device, during a particular growth stage of a crop in the field, the crop defining multiple rows within the field; (b) detecting, by the computing device, the multiple rows of the field in the image; (c) based on the detected multiple rows in the field, separating, by the computing device, the image of the field into multiple sub-images, each sub-image including multiple plants in at least one row of the field; (d) applying, by the computing device, a trained classifier model to the sub-images from the image and classifying, using the trained classifier model, each of the multiple plants included in the sub-images as a rogue plant or as not a rogue plant; and (e) generating an output map of at least the classified rogue plants in the agricultural field, the output map indicative of a location of the rogue plants in the agricultural field.

In another example embodiment, such a method generally includes (a) accessing, by a computing device, data specific to an agricultural field, the data including an image of the field captured, by at least one capture device, during a particular growth stage of a crop in the field; (b) identifying at least one plant included in the image; and (c) applying, by the computing device, a trained classifier model to the image and classifying, using the trained classifier model, the at least one plant included in the image as a rogue plant or as not a rogue plant. In addition, in some example embodiments, the method further includes, (d) in response to the at least one plant included in the image being classified as a rogue plant, striking the at least one plant from the agricultural field at about the same time the at least one plant is classified as a rogue plant and/or the image of the field is captured by the at least one capture device and/or (e) in response to the at least one plant included in the image being classified as a rogue plant, generating an output map for in the agricultural field, the output map indicative of a location of the at least one plant classified as a rogue plant.

In another example embodiment, such a method generally includes (a) accessing, by a computing device, data specific to an agricultural field, the data including an image of the field captured, by at least one capture device, during a particular growth stage of a crop in the field; (b) separating, by the computing device, the image of the field into multiple sub-images, each sub-image including multiple plants; (c) applying, by the computing device, a trained classifier model to the sub-images from the image and classifying, using the trained classifier model, each of the multiple plants included in the sub-images as a rogue plant or as not a rogue plant; and (d) generating an output map of at least the classified rogue plants in the agricultural field, the output map indicative of a location of the rogue plants in the agricultural field.

Example embodiments of the present disclosure also generally relate to systems for use in identifying rogue plants in growing spaces. One example system generally includes at least one processor configured to (a) access data specific to an agricultural field, the data including an image of the field captured, by at least one capture device, during a particular growth stage of a crop in the field; (b) identify at least one plant included in the image of the field in at least one row of the field; (c) apply at least one classifier model to the image to classify, using the at least one classifier model, the at least one plant included in the image as a rogue plant or as not a rogue plant; and (d) generate an output map of the at least one plant in the agricultural field, the output map indicative of a location of the at least one plant and an indication of the at least one plant as a rogue plant or as not a rogue plant. In addition, in some example embodiments, the system further includes (e) the at least one capture device and/or (f) an automated apparatus configured to strike the at least one plant from the agricultural field, based on classification of the at least one plant as a rogue plant, at about the same time the image of the field is captured by the at least one capture device.

Example embodiments of the present disclosure also generally relate to non-transitory computer-readable storage media including executable instructions for use in identifying rogue plants in growing spaces, which when executed by at least one processor, cause the at least one processor to perform one or more of the operations recited in the example methods and/or example system above and/or herein (e.g., as recited in one or more of the claims herein, etc.).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for identifying rogue plants in growing spaces;

FIG. 2 is a block diagram of an example computing device that may be used in the system of FIG. 1;

FIG. 3 illustrates a flow diagram of an example method, which may be used in (or implemented in) the system of FIG. 1, for use in identifying rogue plants in growing spaces;

FIG. 4 illustrates an example image, with a shape file applied thereto, which may be generated through the method of FIG. 3;

FIG. 5 illustrates an example sub-image, in which a portion of plants from the image of FIG. 4 are visible; and

FIG. 6 illustrates an example visual map of rogue plants identified in a field, which may be generated through the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In assessing specific plants in growing spaces, growers may manually inspect the plants, one by one, to ensure expected plants are included in the growing spaces and that the plants are also growing as expected. Plants inconsistent with the expected plants, or divergent from certain growth metrics, may be determined to be rogue plants, as in plants that are undesirable or unwanted as compared to and/or that are inconsistent with the remaining plants in the growing spaces. The use of persons to inspect the crops for rogue plants is generally labor intensive and/or subject to error and/or tendencies (or biases) of the persons involved in the measurements/inspection (e.g., there is no known, accepted automated inspection, etc.). In addition, when the measurements are inaccurate or in error, or even incomplete, actions designed to remove rogue plants from the growing spaces, for example, may be hindered or omitted, thereby retaining a sufficient number of rogue plants in the growing spaces to contaminate the seed/product output of the growing spaces (e.g., which may limit or eliminate the usefulness of the testing in the growing spaces, etc.).

Uniquely, the systems and methods herein provide for automated, objective identification of rogue plants in growing spaces, based on images of the plants in the growing spaces.

In particular, planting and image data associated with a crop in a growing space is captured and processed, whereby one or more classification models may be trained to identify rogue plants (as compared to other plants) within the growing space. The training (and validation) of the classification model(s) may be based on specific processing of image data for growing spaces (e.g., for small plots, large fields, etc.), which provides for row detection and plant identification. The model(s) may then be employed, with the images (specifically, the image data) of the growing spaces, whereby the rogue plants in the growing spaces, if any, are identified. One or more corrective actions may then be taken, based on outputs from the model(s) (e.g., based on a number of rogues, a percentage of rogues, a location of rogues, etc.), whereby the at least a portion of the rogue plants are removed or otherwise struck at the growing spaces and a purity of the crop(s) in the growing spaces is maintained and/or decontamination of the growing spaces (and products therefrom) is promoted and/or ensured. In this manner, an automated, objective measure of identifying rogue plants in a significant number of growing spaces is provided, which eliminates need for manual intervention, improves the purity of the plants in the growing space, and improving the reliability of data derived from the growing spaces (or plants thereof). In addition, in some implementations, automated actions may then be taken to address (e.g., strike, etc.) the identified rogue plants (e.g., to remove the identified rogue plants from the growing spaces, to kill the identified rogue plants in the growing spaces, to inhibit further growth of the rogue plants in the growing spaces, etc.).

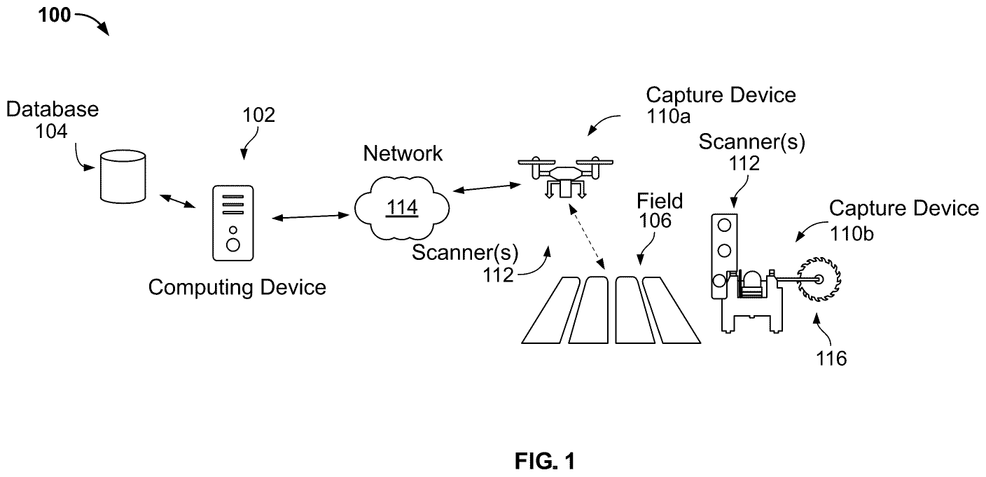

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, sources and/or types of data (e.g., images, etc.), arrangements of plots, types of crops in the plots, etc.

In the example embodiment of FIG. 1, the system 100 generally includes a computing device 102 and a database 104. The database 104 is coupled to (and/or is otherwise in communication with) the computing device 102, as indicated by the arrowed line. The computing device 102 is illustrated as separate from the database 104 in FIG. 1, but it should be appreciated that the database 104 may be included, in whole or in part, in the computing device 102 in other system embodiments.

The system 100 also includes an example field 106 (broadly, a growing space). The field 106 may include dozens or hundreds of acres, and also may be representative of tens, hundreds, or thousands of fields associated with a specific grower (or specific growers). The grower, generally, plants a crop (or crops) in the field 106, potentially applies one or more management practices to the field/plants, and then harvests the crop/plants from the field 106 at an end of the growing season. The grower, in this example embodiment, plants a consistent crop in the field 106 (e.g., the same type of seed variety, etc.), whereby the output from the field 106 (e.g., in terms of yield and/or quality, etc.) is expected to be generally consistent. In this example embodiment, the field 106 includes a specific variety of corn (or maize), whereby the seeds planted in the field 106 are intended to be consistent with that specific variety of corn. That said, in various example embodiments, the present disclosure may be used with other crops, including, for example (and without limitation), corn (or maize), wheat, beans (e.g., soybeans, etc.), peppers, tomatoes, tobacco, eggplant, rice, rye, sorghum, sunflower, potatoes, cotton, sweet potato, sugar beets, sugarcane, oats, barley, vegetables, canola, or other suitable crop or products or combinations thereof, etc. While only one field 106 is illustrated in FIG. 1, it should be appreciated that the system may include multiple different fields within the scope of the present disclosure (e.g., of/for which images may be captured for use as described herein, etc.).

It should also be appreciated that the grower associated with the field 106 may include a private grower for a farm property, a seed producer (e.g., commercial or otherwise, etc.), or any other user or entity associated with one or more fields included as part of the field 106.

As further shown in FIG. 1, the system 100 includes example capture devices 110 (e.g., capture devices 110a, 110b, etc.). As shown, the capture device 110a includes an unmanned aerial vehicle (UAV) (e.g., a UAV, etc.), which includes at least one scanner 112 (e.g., including one or more camera, etc. configured to capture red, blue, green, red-edge, near infrared (NIR), etc. data; etc.). As such, the capture device 110a is configured to travel/fly above the field 106 in the system 100, for example, and to capture one or multiple images of the field 106. In one or more example embodiments, the capture device 110a may include a drone, such as, for example, a DJI Phantom 4 Pro drone, etc., and the scanner 112 may include, for example, a Sentera AGX710 Gimbal device or a Sentera 6X Multispectral sensor device or a Sentera D4K Analytics RGB sensor device, etc., whereby the capture device 110 is configured to capture/sense, for example, via the scanner 112, red, blue, green, red-edge, near infrared (NIR), etc. data from the field 106, etc. It should be appreciated that while only one scanner 112 is illustrated in the capture device 110a in FIG. 1, more than one scanner 112 may be included in the captured device 110a in other embodiments. As such, the capture device 110a may include one scanner 112, two scanners 112, three scanners 112, more than three scanners 112, etc. In addition, other capture devices (e.g., aerial devices, etc.) may be used in the system 100, where the other capture devices may include one scanner, or multiple scanners as desired.

The capture device 110b includes a ground vehicle (e.g., a high clearance tractor such as an applicator, detasseler, etc. from Hagie Manufacturing Company of Clarion, IA., etc.) configured to travel across the ground, and which also includes at least one scanner 112 (e.g., which may again include a Sentera AGX710 Gimbal device, a Sentera 6X Multispectral sensor device, a Sentera D4K Analytics RGB sensor device, a Luxonis OAK-D stereo camera, a point sensor, etc.). Similar to the above, it should be appreciated that while only one scanner 112 is illustrated in the capture device 110b in FIG. 1, more than one scanner 112 may be included in other embodiments. As such, the capture device 110b may include one scanner 112, two scanners 112, three scanners 112, more than three scanners 112, etc. In connection therewith, the capture device 110b also includes tracks, wheels, etc., or broadly, a transport mechanism or device, to move the capture device 110b within a field. The capture device 110b may also include a motor and power source (e.g., a battery power source, etc.) coupled on board the capture device 110b, for example, configured to power the transport mechanism or device and cause movement of the capture device 110b through the field 106. In addition, again, other capture devices (e.g., aerial devices, etc.) may be used in the system 100, where the other capture devices may include one or multiple different scanners.

In one example, the capture device 110b includes three scanners 112 (or cameras), each positioned at a specific height from the ground and/or the plants, creating a different field of view via each camera, and wherein each scanner 112 is adjustable as desired (e.g., vertically relative to the ground, horizontally relative to the plants, rotationally, etc.). The scanners 112 may be mounted on a support that extends upwardly on the capture device 110b. In addition, the three scanners 112 may be aligned so that a 360-degree view of the plants may be captured, from the ground to the top on both sides of the plants. For example, a first scanner 112 may be positioned at between about six inches and about two feed above the ground, while a second scanner 112 may be positioned at about two feet and about five feet above the ground. A third scanner 112 may then be positioned above (or over) the plants and directed essentially downward on the plants in the field (e.g., about seven, eight, nine, ten, etc., feet (or more or less) above the plant (depending on a desired field of view and/or plant), etc.). That said, the above distances/positions of the scanners 112 are example in nature, with it to be appreciated that the scanners 112 may be located at different heights relative to the ground in other example embodiments. While three scanners 112 are included in this example, it should again be appreciated that the capture device 110b may include a different number of scanners, including, for example, additional scanners located on opposite (or different) sides of the capture device 110b than the three provided scanners 112, at different heights relative to the capture device 110b than the three provided scanners 112, etc.

In addition in this example, the capture device 110b may include an inertial measurement unit (IMU) (as part of the scanner(s) 112 or as a separate device) configured to measure and report raw or filtered angular rate data and/or force/acceleration data associated with the capture device 110b. An example depth camera that may be used herein includes a REALSENSE depth camera by INTEL CORPORATION. As such, the scanners may each be configured to simultaneously capture Red-Green-Blue (RGB) image data in the visible light spectrum and depth data representing distance from the respective scanner 112 to a surface of the plant (and other surfaces in the field of view of the camera). The capture device 110b may further include at least one tracking device, which is configured to track and/or capture the IMU data and location data, as the capture device 110b moves in the field. In this manner, the tracking device may include an INTEL RELSENSE T265 device from INTEL CORPORATION and/or a GNSS GPS unit, model DA2, by TRIMBLE INC. Consequently, it should be appreciated that the tracking device may include multiple devices but may include only one tracking device in other examples.

It should be further appreciated that there may be different numbers and/or types of capture devices 110a, 110b and/or scanners 112 in other system embodiments, whereby the number of images, point of view, relative position, ground-based versus aerial, etc., may be other than illustrated in FIG. 1. That said, it should be appreciated that where the description herein generally references a capture device 110, the capture device 110 may include either the capture device 110a, the capture device 110b, or both capture devices.

In the illustrated embodiment, the capture device 110 is configured to capture certain data from the field 106 in one or more growth stages of the crop planted therein. For example, for a corn crop, the capture device 110 may be configured, or programmed, to capture data (e.g., images, times, locations, etc.) at one or more growth stages (e.g., vegetative stages, etc.) of corn between V1 (first leaf) and VT (tassel), or it may be configured, or programmed, to capture data at one or more growth stages of the corn planted up to VT, and more specifically, between V5 and VT, or it may be configured, or programmed, to capture data at one or more growth stages including R1 (silking) through R6 (maturity) (e.g., for foundation seed, etc.), etc. It should be appreciated that the data includes images, and the images may be captured by the capture device 110 in other growth stages of the corn plant, and also various other stages of other crops to be planted in the field 106. It should further be appreciated that the data may be captured by the capture device 110 more than one time in a growing season, in the same or different growth stages, etc. For example, the capture device 110 may be configured to capture data for the field 106 every one, two, five, or eight days within a number of weeks (e.g., two week, five weeks, eight week, twelve week, etc.), depending on, for example, the growth progression of the crop(s) in the field 106, management practices, and/or the type of crop(s) in the field 106, etc. In addition, it should be appreciated that the capture device 110 may be configured to provide real-time capture data (e.g., images, etc.) for the field 106, for use in making one or more decision as described herein.

It should be understood that the various system embodiments herein may include multiple capture devices, which are consistent with the capture device 110, and which are configured to capture data from dozens, hundreds, thousands, or tens of thousands of fields, or more or less, etc. (e.g., including the field 106 and other fields, etc.). In addition, in various embodiments, in capturing images from the field 106 (or other fields), the scanner 112 (or multiple scanners 112 (e.g., two scanners, three scanners, four scanners, etc., in one or more of the capture devices 110, etc.)) may be positioned above the crop canopy, within the crop canopy, and/or below the crop canopy (e.g., depending on a type of the capture device 110, etc.) (e.g., at least one scanner at each position, etc.), and/or may be configured to capture data in desired directions relative to the capture device 110 (e.g., nadir, oblique, zenith, within the canopy, above the canopy, etc.), etc. Further, in one example embodiment, the computing device 102 may be included, in whole or in part, in the capture device 110.

In this embodiment, the capture device 110 may be configured to traverse the field 106 (or other fields) on one or more different patterns, whereby a set of images is captured, which are representative of the entire (or substantially entire) field 106. More generally, when the capture device 110 traverses the field 106, and potentially, neighboring fields, to produce image data for the field 106, the capture device 110 may be configured to make multiple passes through, over, etc. the field 106 (e.g., as defined by geo-spatial data, etc.) and/or abide by travel lines to ensure that sufficient image data for the field 106 is captured. The travel lines may include flight lines, for instance, where the capture device 110 includes the capture device 110a. In such example, the travel lines may make a serpentine path back and forth along/over the field 106 (e.g., in the direction of the rows and/or perpendicular to the rows, etc.), and may include multiple, intersecting lines to capture duplicate point data for each location (or multiple locations) of the field 106 (which is also captured and stored by the scanning device 112), etc. In addition, the travel lines may include row lines, for instance, where the capture device 110 includes the capture device 110b.

Further, the capture device 110 may be configured to obtain location data for each of the captured data points (e.g., based on location/position data of the capture device 110 (e.g., via a global positioning system (GPS) unit of the capture device 110 and/or the scanning device 112, via direct geo-referencing, etc.), etc.) in the field(s), which may be corrected and/or refined, as needed, utilizing position correction hardware, for example, in the form of a ground station, etc.

In addition to the travel lines described above, the capture device 110 may also be configured to capture image data at certain heights. For instance, where the capture device 110 includes the UAV 110a, the UAV 110a may be configured to abide by a specific altitude (or altitude range, or altitude minimum, or altitude maximum) (e.g., 100 feet, 200 feet, etc.), at which the scanner(s) 112 is(are) permitted, enabled and/or optimized to operate as described herein, in the direction of rows of plants in the field 106 (or other field(s)), or transverse to the direction of the rows, and also a particular speed (or speed range, or speed minimum, or speed maximum) (e.g., a speed of about 10 mph or more or less, etc.), and a particular image overlap of the field 106, for example, to confirm complete image coverage of the field 106 as is desired and/or appropriate (e.g., an overlap percentage of about 80%, an overlap of about −300%, other discrete overlaps therebetween, etc.). In one example, when the altitude of the capture device 110a is about 300 feet, the scanner 112 may capture one image for every about 1.5 acres of the field 106, with each image having an area of about 0.1 acres.

Where the capture device 110 includes the land vehicle 110b, the vehicle 110b (e.g., the scanner 112 thereof, etc.) may be configured to capture images, in this example, at heights of about fifteen feet or less, about 10 feet or less, etc. (e.g., including above a canopy of the plants in the field 106, within the canopy of the plants in the field 106, and/or below the canopy of the plants in the field 106, etc.). In doing so, the land vehicle 110b may be configured to traverse the field 106 at speeds of between about 2 mph and about 10 mph, etc. The captured images may include part of a plant, one plant, multiple plants, etc. In addition, the vehicle 110b may be configured to capture a top of a plant, a side of a plant, and/or a bottom of a plant. The vehicle 110b may be configured to capture images of several plants, or a portion of each of several plants. In some examples, the land vehicle 110b may capture images of every plant in every row of the field 105. Further, in some examples, the vehicle 110b may capture images more frequently than once per plant, for example, in order to choose the image best centered on each plant, or to use multiple images to improve accuracy (e.g., where the images may include leaf instance images, stalk instance images, root instance images, tiller instance images, etc.).

That said, it should be appreciated that the capture device 110 may be configured to abide by other specifications in other embodiments, for example, other speeds (e.g., slower than about 10 mph, faster than about 10 mph, etc.), other flight patterns, other travel/movement patterns, etc.

In connection with the above, and the capture of images by the capture device 110, a negative image overlap, such as an overlap of −300%, for example, may generate individual scouting point images (e.g., images providing less than full field coverage, etc.). As such, the image data used herein may include images of less than a full field. An image overlap of between 0% and 65%, however, may not produce individual scouting point images and/or may product a map of an entirety of the field.

In another example, in connection with the capture of images by the capture device 110, a positive image overall, such as an overlap of greater than 0%, an overlap of about 65% or greater, etc., may generate sufficient image data to create a full field stitched mosaic image covering the field 106 (e.g., covering every inch of the field 106, etc.). That said, creating such full field mosaics is not required (or may not be applied) in all embodiments (e.g., such full field mosaics may only be generated for fields having sizes of about 10 acres or less but not for full sized production fields having sizes of greater than about 10 acres, etc.).

Further, following the above, the capture device 110 is configured to store the captured data in the database 104, directly or via the computing device 102, via network 114, etc., whereby the capture device 110 and/or the scanning device 112 is configured to communicate with the database 104 and/or the computing device 102 via the network 114. In turn, the database 104 is configured to receive and store the image data from the scanning device 112 (directly, or via the computing device 102). It should be appreciated that the image data from the capture device 110 is stored in the database 104 for multiple seasons for the field 106 and various other fields. The image data may include data as described herein including, for example (and without limitation), a name or other identifier for the device at which the data was captured, a device model, a capture time, a capture date, location data for the corresponding image data, an indication of the field(s) for which the image data relates, aperture data, exposure data, individual band data, camera/device settings, user/operator data, field notes, start/stop times for imaging, imaging duration times, travel log data for the device 110, coverage maps for the captured image data, images, etc.

As described, it should be appreciated that a desired number of capture devices 110 may be used herein. That said, while only two capture devices 110a, 110b are illustrated in FIG. 1, for purposes of simplicity, it should be appreciated that the system 100 may include (and in several implementations will include) multiple such devices. What's more, as also described, the illustrated capture devices 110a, 110b include the UAV and the ground vehicle, while a combination of the same is not required. It should also be appreciated, though, that the system 100 may include one or more additional, alternate mobile scanning devices (e.g., manned aerial vehicles (MAVs), etc.), or fixed scanning device (e.g., pedestal mounted, tower mounted, etc.). Consistent with the above, the capture devices, whether mobile or not, are configured, like the capture device 110, to capture image data for associated fields (including image data above a canopy of a crop in the field 106, within a canopy of the crop in the field 106, and/or below the canopy of the crop in the field 106, etc.) and to store image data for the associated fields in the database 104.

Additionally, in this example embodiment, the database 104 may be further populated with other relevant data, associated with the field 106 (and other fields), the plants in the field 106 (and in other fields), or other relevant data. In particular herein, the database 104 includes boundary data for the field(s) herein, which define the different field(s) associated therewith (e.g., where the field 106 incudes multiple fields/locations the boundary data may define each of the multiple fields/locations within the field 106, etc.), plots associated therewith, obstacles located within the field(s), etc., based on geographic coordinates. The database 104 may also include crop data, such as, for example, which crops are planted in the field(s) (and associated details of the crops), where different crops are planted in the field(s), a number of rows in the field(s) (and locations of the same), a planting rate or density of plants in the field(s), planting dates for the plants in the field(s) (and/or growing stage observations and/or predictions, etc.), environmental and/or phenotypic data for the plants, types of plants, male versus female plants, fertile versus sterile plants, etc.

In this example embodiment, the computing device 102 is configured to access captured data from the database 104 (and/or the capture devices 110) and to identify rogue plants, if any, in the field 106, for example, based on the captured data, via the capture devices 110, whereby the rogue plants may be located and excised (e.g., automatically in some embodiments, etc.) from the field 106, etc.

In particular, the computing device 102 is configured with a model, which is trained based on data (e.g., historical data for the field 106 and/or other field(s), etc.) and then usable based on data to identify rogue plants in the field 106 (and other fields as desired). In connection therewith, the model is initially trained. To do so, in this example embodiment, the computing device 102 is configured to access data from the database 104 (e.g., for a desired period of time such as the last two years, the last four years, a given two-year period, a given four-year period, other periods, etc.). The accessed data, used to train the model, includes image data for various fields, including the field 106 (in past seasons) and/or various other field(s), for example, which has been captured by the capture devices 110a, 110b (and/or other capture devices). The data may include, for example, red, green, blue, red-edge and/or NIR data, which defines image data, and also spatial data such as height, depth, and orientation. As such, in some embodiments, the data may include high resolution image data on the order of, for example, about 5 mm per pixel or better (e.g., a resolution of about 5 mm or less per pixel, about 3 mm or less per pixel, 1 mm or less per pixel, or between 0.1 mm and 0.5 mm per pixel, or otherwise, etc.). The data is associated, in the database 104, with field identifying data, for example, a field identifier and/or location data, etc. for the field with which the data is associated, etc. For the training data, the data further includes rogue plant designators associated with the image data, which is indicative of specific locations within the image data that include rogue plants. The rogue plant designators may be based on intentionally including rogue plants in a given field (e.g., planting off-types or inconsistent types of seeds, manipulating the plants during the growing season, etc.), or based on manual review of plants included in the images/fields and designating particular ones as rogue plants. That said, it should be appreciated that the data above may be data collected, measured, or otherwise obtained from a field, and/or it may include simulated data based on one or more models associated with appropriate field data, planting data, etc.

In addition to the image data, the computing device 102 is configured to access certain data for the field 106 (and/or other field(s)). In this example embodiment, the data (e.g., planting data, field data, etc.) is for corn and may include, without limitation, data for pre-tassel such as plant health attributes (i.e., disease or nutrient induced differences in visual characteristics), vigor, planting date, growth stage, color, plant size, plant height, leaf length, leaf area, midvein color, midvein width, leaf orientation, as well as data for post-tassel including tassel size, tassel thickness, tassel branching, tassel color, pollen presence, stem width, brace root presence, brace root color and architecture, leaf node distance, etc. It should be appreciated that more or less or different data may be employed in other system embodiments. In connection with the above, in this example embodiment, rogue corn plants may then include, without limitation, hybrid plants (present in inbred fields, etc.), off-type plants, plants having growth delays (for pre-tassel rogues), female sterility breakers, plants deemed sterile yet that shed pollen (for post-tassel rogues), diseased or mutated plants (e.g., plants exhibiting bleaching or having the mosaic virus, etc.), etc.

Given the above data, the computing device 102 is configured to then format the data in advance of training the model (using the data).

Formatting of the data for aerial images and ground-based images may be resolved differently, in this example. For instance, for aerial images, the computing device may be configured to detect the rows of crops in the images, and to apply a moving window or box along each detected row in order to crop limited sections of the image (e.g., whereby a few plants from the same row and a few from the two adjacent rows (e.g., one row on each side, etc.) are visible, etc.). It should be appreciated that other detecting and/or cropping of the image data may be employed in other embodiments.

For ground images, the computing device 102 may be configured to synchronize video feeds collected by the scanners 112 (e.g., as mounted on the capture device 110b, etc.) (e.g., for a given row of the crop plants, etc.). The computing device 102 is configured to perform the synchronization, based on a calibration step between the different scanners 112. The scanners 112 may be, for example, synchronized with respect to a master clock, thereby confirming capture of the same plant from different angles with a limited interval of accuracy (e.g., within a few milliseconds, etc.). The computing device 102 is configured then, by a stem detection algorithm, to generate signals to indicate that a plant is at the center of all the synchronized camera views. The computing device 102 is further configured, by the stem detection algorithm, to extract information on the stem phenotype, such as, for example, width, height between the ground and a first true leaf, principal direction, etc. At the same time or about the same time, the scanners 112 also capture images of the foliage, whereby the computing device 102 is configured to perform a leaf segmentation for the ground-based images captured by the capture device 110b. The computing device 102 is configured to then match the segmented leaves with the centered plant, based on proximity and orientation, and to extract phenotypic characteristics, such as, for example, lengths, widths, vein widths, etc. Thereafter, the computing device 102 is configured to combine the phenotypic features from stems and leaves.

Next, the computing device 102 is configured to separate first plot data, or plot-scale data (e.g., plot image data, etc.) from second field data, or field-scale data (e.g., field image data, etc.), within the data in the database 104, where the plot-scale data includes small plot trial mosaics of areas included in the field 106 (and/or other field(s)), for example, and the field-scale data includes large field spot scout data of areas included in the field 106 (and/or other field(s)), for example. In connection therewith, the plot-scale plot data may be used for phenotypic selection, early line purity evaluation, etc. And, the field-scale data may be used to evaluate larger production acreages based on a subsample of the entire location instead of every plant across the entire field.

With regard to the plot-scale data, the computing device 102 is configured to then apply a shape file to the plot-scale data, which defines plot grids over the plot-scale data. In doing so, the computing device 102 is configured to define multiple plots in the plot-scale data. Next, the computing device 102 is configured to crop the plot-scale data to the defined plots. To the extent that separate treatments are defined for the fields/plots included in the plot-scale data, those plots are also separated and/or designated.

Thereafter, for the plot-scale data, the computing device 102 is configured to apply one or more row detection algorithms to the images, and to designate or annotate crop rows with unique identifiers (e.g., Plot1_Row12345, Plot1_Row12346, Plot1_Row12347, etc.).

In some examples, this may include mapping plants in the field(s) (as represented by the images), for example, based on data obtained from the scanner 112 of the ground vehicle 110b, etc. For instance, the scanner 112 of the ground vehicle 110b may be configured to obtain images (multiple per row) of the plants in a field through a video feed, where the algorithm(s) subsequently break the video feed into single images which also include images of single plants. The images of the single plants may then enable a plant count, by counting the number of plants since a beginning of a pass in the field, for example, and thereby creating a plant map of the field by each row. The plant map may then help identify, through a time series signal, rogue plants in the given field to a mechanical system (e.g., a mechanical striking system, etc.) (e.g., whereby the mechanical system may be operated to strike the rogue plants in the field 106 (e.g., remove, treat, etc.), etc.), etc. In connection therewith, in some examples, the mechanical system may be configured to strike the rogue plants based on a time/distance offset between the ground vehicle 110b (e.g., the scanner 112 of the ground vehicle 110b, etc.) and the mechanical system (e.g., apparatus 116, etc.). Further, in some examples, the mechanical system may be configured to strike the rogue plants based on a geospatial relationship between the ground vehicle 110b (e.g., the scanner 112 of the ground vehicle 110b, etc.) and the mechanical system (e.g., apparatus 116, etc.) to determine a location of the rogue plants (e.g., via representation of geographical coordinates of the rogue plants against a geographical context of a field in which the rogue plants are located, in order to present a model of the field and rogue plants on a map; etc.).

In some examples, the capture device 110a may be used to map the plants in the field (alone or in combination with the capture device 110b). In turn, the map may then be used as the basis for striking rogue plants in the field (e.g., via apparatus 116 of capture device 110b, via another mechanical system configured to strike rogue plants from the field, etc.). In connection therewith, the given mechanical system (e.g., be it apparatus 116 or another mechanical system, etc.) may be configured to strike the rogue plants based on count of the plants in the row/field and/or based on a geospatial relationship between the ground vehicle 110a and/or 110b (e.g., the scanner 112 of the ground vehicle 110a and/or 110b, etc.) and the mechanical system to determine a location of the rogue plants.

The computing device 102 is configured to then separate the crop rows into sets of individual plants, such as, for example, four or five plants, or more or less plants, etc. In some example embodiments, each plant in the given field (of which the image(s) represent) may be given an identifier to thereby identify the plant (e.g., as either acceptable or as a rogue that needs to be removed, treated, etc.). As a result, the computing device 104 includes image data for the field, as the data in this example, which is segregated into small groups of plants, where each plant in the given group is either identified as a rogue plant or not a rogue plant. In addition, in some example embodiments, the computing device 104 may further be configured to use the image data described herein to further classify the rogue plants in the field, for example, as a hybrid, an inbred, a delay, etc. and also gather attributes or reasons for why the given rogue plant was removed or otherwise struck from the field (e.g., plant height, leaf width, stem width, a combination thereof, etc.).

The computing device 102 is configured to then separate the data into a training data set and a validation data set (broadly, into training data and into validation data). The computing device may separate the data based on date, such as, for example, one year left out, or based on some random selection of data (e.g., based on available data, etc.), etc., whereby the training data set is representative of the field 106 (and/or other field(s)) and the validation data set is representative of the field 106 (and/or other field(s)), for example, and instructive of rogue plants in the field 106 (and/or other field(s)). That said, it should be appreciated that the training data and the validation data may be associated with the same field, or may come from different fields, within the scope of the present disclosure.

From the above, in this example, the computing device 102 is configured to train a classification stage, which may include, for example, one or more model paths used independently or in combination. In connection therewith, a first model path may be configured to transform an image into a mathematical vector (e.g., an array of numbers, etc.) and then classify the vector into the rogue/non-rogue classes. Here, a first step may define a representation of an image as a mathematical one-dimensional vector in a mathematical space where all similar images are projected close to each other. Generative Adversarial Networks (GANs) and AutoEncoder Networks (AEs) may be used to achieve this transformation, including, for example, the CycleGAN, the StyleGAN, the Variational AE, SimCLR, and others. These networks are configured to receive an input image and output an alternative version of that image, by transforming the input image to a vector, and then transforming the vector into the final, output image.

A second step, then, may define the classification of the vector representations of the input images into rogues/non-rogues. Since the classification algorithm acts on a mathematical vector input, a binary classifier may be used to achieve such classification such as, for example, the Support Vector Machine (SVM) classifier, etc. ne or more model paths used independently or in combination. A second model path may include an autoencoder neural network model for processing images, which are then classified by a defined reconstruction loss threshold. And, a third model path may include an instance segmentation network such as SOLOv2 or RTMDet, configured to identify individual instances of leaves, stems, or other plant parts and produce a set of instance masks (e.g., in real time, etc.). Measurements of the leaves and stems, such as width, length, and area, may then be made from the instance masks using computer vision techniques, such as reducing the masks to simple components with skeletonization techniques (e.g., reduction to one dimensional line segments, etc.) or shape fitting techniques (e.g., reduction to simple shapes such as, but not limited to, ellipses, rectangles, etc.; etc.), or the cv::boundingRect function from OpenCV, etc. One or more measurements may be used for classification through statistical models or machine learning. It should be appreciated that other processing and/or classification models may be used in other embodiments, whereby the specific data above is input to model a classified output (i.e., a rogue plant or not a rogue plant).

In connection with the above, in example embodiments, multiple images may be used to classify a plant. In doing so, each image may includes parts of multiple plants. As such, a multi-step process may be employed in these embodiments. In a first step, instance classification is performed on the entire image, or a cropped portion of the image, for each of three images, including a top sensor/camera image (leaf instances), a middle sensor/camera image (leaf instances), and a bottom sensor/camera image (leaf, stalk, tiller, and/or brace root instances). In a second step, measurements are determined regarding the instances (e.g., regarding the leaf instances, root instances, stalk instances, tiller instances, etc.). And, in a third step, the measurements are used to classify a plant as a rogue. This classification step relies on all, or at least a portion of the instance(s) in the image(s), not just those belonging to the center plant. The classification step also relies on measurements (e.g., mean and deviation, etc.) from the last N images (e.g., last ten images, last twenty images, last thirty images, last forty images, last fifty images, last one-hundred or more images, values therebetween, etc.). The measurements may be employed to vary the threshold, i.e., as a rolling threshold, to account for the variability in the field to prevent or limit the potential for errant classification and/or unintended elimination.

That said, in some embodiments, multiple model paths may be used in combination to increase efficiency. Such multiple model paths may include, for example, the StyleGAN deep machine learning model and the autoencoder neural network model. In another example, the multiple model paths may include an autoencoder neural network model making an initial estimate on the abnormality of a plant and then triggering the RTMDet instance segmentation model, followed by mask simplification (e.g., measurement techniques, etc.) and classification (e.g., statistical classification, etc.), to verify the initial guess.

After the training data set is used to train the model(s), the computing device 102 is configured to use the validation data set to validate the trained model(s). In this example, the validation of the model is based on a validation threshold, which is generally dynamic and which may be set based on the specific application of the model. The specific application may indicate a type of a crop, an acceptable amount of false positives and/or false negatives that can be accepted, etc. In connection therewith, the computing device 102 is configured to validate the model based on, for example, a brute force technique with a range of parameters and thresholds. The different sets of parameters result in different evaluations of the classification criteria. The classification criteria may include precision, recall, f1-score, and mean square error (average of how many plants were misclassified regardless of whether they were false positives or false negatives), etc. For the specific application, in some embodiments, a user may then select an appropriate parameter (or set of parameters), based on the above metrics. In one example, the user may select to eliminate all rogues, whereby the user may request a set of parameters to maximize recall.

Thereafter, when validated, the model(s) may be used to classify plants within image data, for example, as part of the field 106 (or potentially, as part of other fields), as either rogue plants or not rogue plants. In this example embodiment, the image data is captured from the field 106, consistent with the description above, and then processed consistent with the description above. The computing device 102 is configured to expose the image data to the trained model, and then to determine a number of rogues per image and, potentially, to also convert the rogues per image to rogues per acre (whereby each identified rogue is designated as a rogue plant).

The computing device 102 is further configured to generate an output report, which includes a map of the field 106, for example, a symbol at each location of a plant and/or at each location of a rogue plant in the field 106 along with the rogue counts, rogue types (e.g., hybrid, delay, off-type inbred, malformed, genetic striped, diseased, outcrossed, etc.), counts of rogue types, densities, rates of occurrence, and/or other metrics associated with the field 106. The report may further include one or more characteristics for the plants identified as rogue and/or classes for the plants, for example, providing an indication of why the plant was identified as a rogue plant, etc. (e.g., identifying the plant as a hybrid, an inbred, a delay, etc. and also indicating attributes or reasons for why the given rogue plant was removed or otherwise struck in the field (e.g., plant height, leaf width, stem width, a combination thereof, etc.), etc.). Upon review, the grower associated with the field 106 may decide to strike (e.g., remove, etc.) the rogue plants in/from the field 106, or not, depending on one or more defined thresholds for rogue plants in the filed 106 and the provided counts and/or metrics. In some examples, this may be done at about the same time (e.g., within minutes or faster (e.g., within about sixty minutes, within about thirty minutes, within about ten minutes or faster, within about five minutes or faster, within about one minute or faster, within about thirty seconds or faster, etc.), etc.) the at least one plant is classified as a rogue plant and/or the image of the field is captured by the at least one capture device. Or, in some examples, this may be done later, based on the mapping of the at least one plant classified as a rogue plant in the field.

In example embodiments, an automated apparatus 116 (e.g., an automated striking apparatus, etc.) is included in the capture device 110b, where the automated apparatus 116 may be implemented to strike the identified rogue plants in the field 106. As used herein, the term “strike” may include any form of removal, neutralization, destruction or disabling of the plants by the apparatus 116. In one example, striking of the plant may include cutting the plant and leaving it in the field. In another example, striking the plant may include treating the plant (or otherwise affecting the plant) to kill the plant (while leaving the actual plant in place in the field 106) (e.g., chemically treating the plant, burning the plant, etc.).

In connection therewith, the system may include one or more terrestrial ground vehicles, drones, etc. in communication with the computing device 106 and configured to identify the rogue plants to be struck (e.g., based on the mapping described above, in real time based on identification of the rogue plants by the device 110, etc.). In one particular embodiment, the capture device 110 may be configured to identify a rogue plant in a field as it traverses the field 106 and, in real time as the plant is identified (or, in some examples, as the image of the plant is captured) (e.g., or within less than a minute, one minute, three minutes, five minutes, etc.) also remove (or cause removal of or cause destruction of) the rogue plant from the field 106, by the apparatus 116. In doing so, the system may include the apparatus 116 with the capture device 110 or traveling in communication with the capture device 110b. The apparatus 116, then, may be configured to mechanically remove the identified rogue plant (e.g., cut, saw, chop, strike the plant with blade, etc.), or laser cut the plant, water or air jet cut the plant, or chemically inject or spray the plant, electrify cut/remove the plant, and/or burn the plant (e.g., via nitrogen or a flame, etc.), chemically treat the plant, etc. That said, it should be appreciated that the apparatus 116 may include a device configured to travel along the ground (e.g., apart from the captured device 110 or connected thereto, etc.) or it may include an aerial device (e.g., apart from the captured device 110 or connected thereto, etc.), etc.

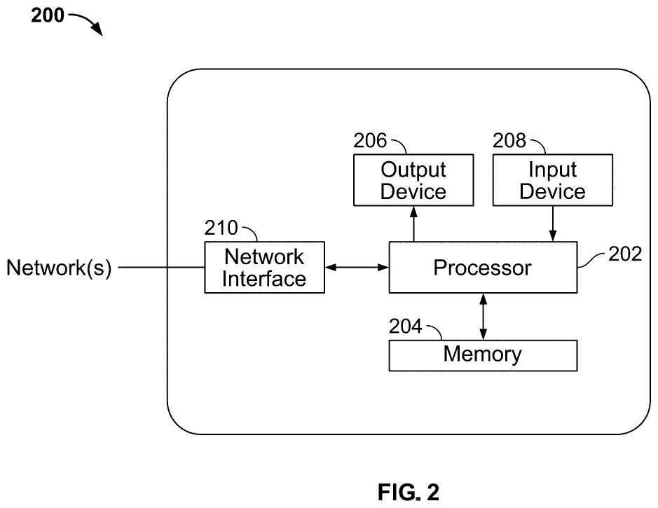

FIG. 2 illustrates an example computing device 200 that may be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity to each other or distributed over a geographic region, so long as the computing devices are specifically configured to operate as described herein.

In the example embodiment of FIG. 1, the computing device 102, the capture device 110, and the scanner 112 each includes and/or is each implemented in one or more computing devices consistent with computing device 200. The database 104 may also be understood to include and/or be implemented in one or more computing devices, at least partially consistent with the computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including, without limitation, scan data, images (e.g., images received from the capture device(s) 110, etc.), image data, model architectures, parameters, crop data, field data, phenotypic data, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202 (e.g., a presentation unit, etc.). The output device 206 may output information (e.g., field maps, rogue identifiers, signals to removal systems to remove rogue plants, etc.), visually or otherwise, to a user of the computing device 200, such as a researcher, grower, etc. It should be further appreciated that various interfaces (e.g., as defined by network-based applications, websites, etc.) may be displayed or otherwise output at computing device 200, and in particular at output device 206, to display, present, etc. certain information to the user. The output device 206 may include, without limitation, a liquid crystal display (LCD), a light-emitting diode (LED) display, an organic LED (OLED) display, an “electronic ink” display, speakers, a printer, etc. In some embodiments, the output device 206 may include multiple devices. Additionally or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of crops, fields, plots, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment the input device 208 may be integrated and/or included with the output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including the network 114 or other suitable network capable of supporting wired and/or wireless communication between the computing device 200 and other computing devices, including with other computing devices used as described herein (e.g., between the computing device 102, the database 104, the capture device 110, etc.).

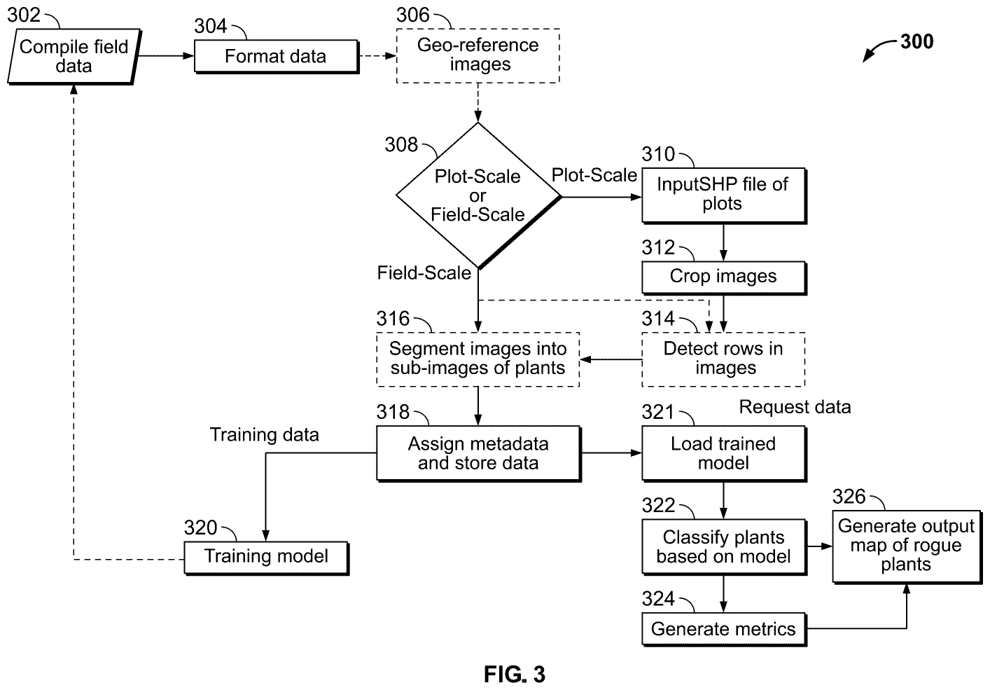

FIG. 3 illustrates an example method 300 for identifying rogue plants in growing spaces. The example method 300 is described herein in connection with the system 100, and may be implemented, in whole or in part, for example, in the computing device 102 of the system 100. Further, for purposes of illustration, the example method 300 is also described with reference to the computing device 200 of FIG. 2. However, it should be appreciated that the method 300, or other methods described herein, are not limited to the system 100 or the computing device 200. And, conversely, the systems, data structures, and the computing devices described herein are not limited to the example method 300.

At the outset, it should be appreciated that the method 300 is directed, in the description below, to the field 106 in the system 100 (broadly, as a growing space) and also with reference to the images of FIGS. 4-6. However, the method 300 may be applied to additional, or different fields in other embodiments, which may be reflected in a variety of different images.

Further, it should also be appreciated that the database 104 includes various data, including image data for a variety of fields, including the field 106 and/or various other fields, along with plant data and rogue plant data for prior plantings of the fields (e.g., for a desired period of time such as the last two years, the last four years, a given two-year period, a given four-year period, other periods, etc.). At 302, the computing device 102 compiles field data for fields (including for the field 106), for example, which may be specific to a region in which the field 106 is located, to a crop (e.g., as included in the field 106, etc.), etc. The region may include a county, state, band (e.g., relative maturity band, etc.), or other geo-political or natural boundary, etc. In general, the region includes a similar or like growth response for the crop planted in the field 106 (e.g., based on planting dates for the crop, management practices, genotypes, etc.), whereby fields within the region generally have consistent growth stages at a given interval in time.

As explained above, the compiled data includes image data for the fields in the region, including the field 106. The image data may include red data, blue data, green data, red-edge data, NIR data, stereo data (e.g., Lidar data, etc.), and/or spatial data, over time, for the fields, and which is captured by the capture device 110 (and, potentially, additional capture devices). The image data may include images over one or more growth stages of the field 106 (and other fields), for example, such, as V5-VT or longer or shorter. Each image in the image data is associated with a location or other field information and/or indicia, by which the images are linkable to a particular field, such as, for example, the field 106. In addition, each image in the image data may be associated with a time of capture to further help link images captured at the same time, etc.

The compiled data also includes pre-tassel data and/or post-tassel data, for example, for corn in this particular example. For example, the pre-tassel data may include, without limitation, plant health attributes (i.e., disease or nutrient induced differences in visual characteristics), vigor, growth stage, color, plant size, plant height, leaf length, leaf area, midvein color, midvein width, leaf orientation, stem thickness or diameter, brace root architecture, brace root color, leaf node distance, etc. And, the post-tassel data may include, without limitation, tassel size, tassel thickness, tassel branching, tassel color, and pollen presence, etc.

Finally, in a training phase of the method 300, the compiled data also includes designators for rogue plants within the fields of the region, which indicate, for a given field, in a growing year, which plants were and were not rogue plants. The compiled data links the specific designators to the plants represented in the image data captured from the capture device 110 and other capture devices.

At 304, the computing device 102 formats the compiled data, and in particular, the image data. The formatting includes, for example, different techniques based on the specific type of image data, i.e., aerial data or ground data. In one example, for aerial images (or aerial image data), each of the rows of crops is detected in the images. Row detection may be based on, for example, the Hough transform for line detection to detect a pattern of parallel equidistant lines as provided by Winterhalter et al. (Winterhalter et al., “Crop Row Detection on Tiny Plants with the Pattern Hough Transform,” IEEE Robotics and Automation Letters, June 2018). After detecting the rows, a moving window or box is applied to the image, and then progressed along the rows of crops, to thereby crop sections of the images, which include one (or two, three, four, or five, etc.) plant(s) in the row and then, potentially, one or more plants in the neighboring rows. The cropped images then proceed in the method 300.

In another example, for ground images (or ground image data), the computing device 102 synchronizes video/image data from the capture devices 110b (i.e., from multiple scanners 112 thereof, etc.), for example. The synchronization may be performed in connection with a calibration step between the scanners 112, whereby the video/image data is synchronized according to, for example, a master clock of the capture device 110b (or global master clock, etc.) (e.g., images from different scanners 112 capturing the same plant from different angles within a few milliseconds accuracy, etc.). Next, in formatting the ground images, in this example, the computing device 102 relies on a stem detection algorithm to generate signals to indicate that a plant is at the center of all the synchronized images. The stem detector algorithm, then, extracts data indicative of the stem phenotype, such as, for example, width, height between the ground and first true leaf, principal direction, etc. In connection therewith, the computing device 102 also performs leaf segmentation of the images. The segmented leaves are matched with the centered plant based on proximity and orientation and phenotypic characteristics such as their lengths, widths, vein widths, and others are extracted as data, etc. Alternatiely, in some embodiments, instead of matching the leaves with the centered plant, the leaves near a center of the given image are used as part of such segmentation (e.g., without being matched to any plant, etc.). The computing device 102 may also (or alternatively) utilize multiclass instance segmentation to detect brace roots, tillers, stalks, combinations thereof, etc. of plants (e.g., instead of leaves, in addition (or in combination with) leaves, etc.).

At 306, optionally, in this example embodiment, the computing device 102 geo-references the images included in the image data (e.g., via direct geo-referencing, etc.). In connection therewith, certain geographical data may be associated with the images. For instance, for images associated with capture device 110a, the images may be geo-referenced with latitude, longitude, altitude, yaw, pitch, and roll, etc. of the scanner(s) 112. And, for images associated with the capture device 110b, the images may be geo-referenced with latitude, longitude, altitude, etc. of the scanner(s) 112.

The computing device 102 then determines, at 308, whether each image is associated with a plot-scale geography or a field-scale geography, where the plot-scale geography is a generally small plot (e.g., about 2.5 feet by about 10 feet, about 2.5 feet by about 20 feet, about 5 feet by about 20 feet, about 0.0023 acres or less, about one acre or less, about two acres or less, about five acres or less, etc.) and the field-scale geography is a generally large field of multiple acres (e.g., more than one acre, more than ten acres, more than 100 acres, etc.).

When the image is a plot-scale image, the computing device 102 applies a shape file (SHP file) to the image, at 310, whereby a grid of lines is applied to the image. FIG. 4 illustrates, at grid 400, an example of a shape file applied to an image of a field. As shown, the grid 400 delineates the field into distinct, non-overlapping sections. With reference to FIG. 3 again, at 312, the computing device 102 crops the images to the grid of the shape file. To the extent that the field 106, in this example, is subject to one or more treatments, the field 106 is also cropped or otherwise adjusted to identify each section as either treated or not treated (but not both).

And, at 314, the computing device 102 optionally performs row detection on the plot-scale image, whereby the rows of the field 106 (in the given plot-scale image), for example, are identified (e.g., in a similar manner to that performed at 304, etc.). The row detection may be based, for example, on a planting direction of the field 106, or other data for the field 106, and/or based on image detection within the image(s) of the field 106 and/or special color variation of the image(s) of the field 106, etc. It should be appreciated that in some example embodiments, the computing device 102 may also perform, optionally, row detection on the field-scale images, in a same or similar manner, as indicated by the dashed lines in FIG. 3.

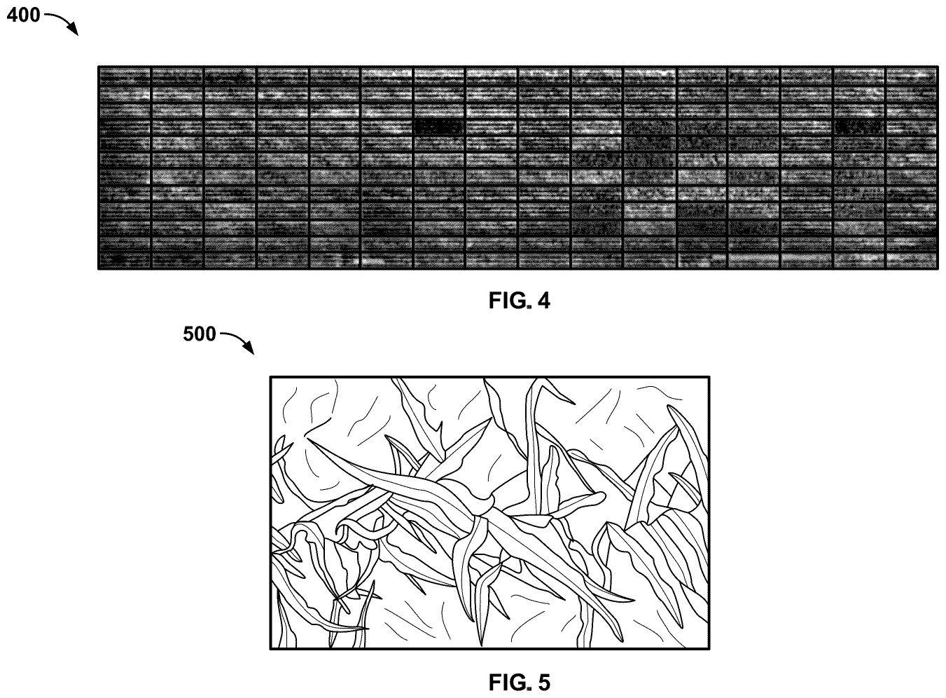

Then, regardless of whether the given image is associated with a plot-scale geography (cropped) or a field-scale geography, the computing device 102 may optionally segment, at 316 (as indicated by the broken lines in FIG. 3), the image into sub-images of the rows, where the sub-images each include only a few plants, for example, three plants, four plants, five plants, eight plants, or more (or less), etc. The sub-images may include a portion of the original image, or they may include an image (e.g., one frame, etc.) taken from a video feed (and still considered a sub-image herein). FIG. 5 illustrates a sub-image 500 from the image of FIG. 4. The sub-image 500 includes only four plant in one row of the field of FIG. 4, for example.

With reference again to FIG. 3, the computing device 102 then assigns metadata to the images and stores the data, at 318. The metadata for the field 106, for example, may include the compiled data for the field, including, without limitation, field identifiers, crop type, phenotypic data (pre-tassel or post-tassel), location, etc. In storing the data, the computing device 102 then also separates the data into a training data set and a validation data set.

As part of a training stage, as generally described for the system 100, the computing device trains, at 320, one or more models with the training data set (for use independently or in combination). In one example embodiment, the computing device 102 may include two model paths: a first model path defined by (i) an RTMDet instance segmentation deep learning model for detecting individual leaves in images and (ii) a process of extraction of related phenotypical features that feed a real time statistical classifier for classifying rogues based on the processed images, and a second model path defined by (iii) a different instance segmentation deep learning model that supports the decision of the first model path via the processing of alternate plant viewpoints and whose aggregate decision is then classifying the abnormality of a plant by (iv) a defined threshold. In another example embodiment, in connection with such training, the computing device 102 may again include two model paths, where in this embodiment: a first model path defined by (i) a style generative adversarial network (StyleGAN) deep machine learning model for processing images and (ii) a support vector machine (SVM) for classifying rogues based on the processed images, and a second model path defined by (iii) an autoencoder neural network model for processing images, which are then classified by (iv) a defined reconstruction loss threshold.

Next, the computing device 102, as part of training the model(s), validates the model(s) based on a validation data set. The model(s) are determined to be sufficiently accurate and validated when a sufficient number or percentage of the rogue plants in the validation data set are identified accurately (e.g., limited number of false positives and false negatives, etc.). Thereafter, the trained model(s) are stored in the database 104, by the computing device 102, and retrained at one or more intervals.

Then in the method 300, in response to a request to identify rogues in field 106 in the current growing season (e.g., from a grower, supplier, etc.), for example, the method 300 compiles, at 302, the data for the field 106 in a current season, where the data includes images of the field 106 during the specific growth stages, as explained above. The compiled data may also include planting data, phenotypic data (e.g., a phenotypic profile of multiple characteristics suggesting that a plant having such characteristics is a rogue plant or is not a rogue plant, etc.), row width data, planting population data, are examples.

As explained above, at 304, the computing device 102 formats the compiled data, particularly, the image data for the current growing season, and at 306, the computing device 102 optionally geo-references the images included in the image data.

The computing device 102 determines, at 308, whether each image is associated with a plot-scale geography or a field-scale geography, again where the plot-scale geography is a generally small plot and the field-scale geography is a large field of acres. When the image is a plot-scale image, the computing device 102 applies a shape file to the image, at 310, whereby a grid of lines is applied to the image. At 312, the computing device 102 crops the images to the grid of the shape file. To the extent that the field 106, in this example, is subject to one or more treatments, the field 106 is also cropped or otherwise adjusted to identify each section as either treated or not treated (but not both). And, at 314, the computing device 102 performs row detection on the plot-scale images, whereby the rows of the field 106, for example, are identified.

Then, regardless of whether the given images are associated with the plot-scale geography (and cropped) or the field-scale geography, the computing device 102 may optionally segment, at 316 (as indicated by the broken lines in FIG. 3), each image into sub-images of the rows, where the sub-images each include, again, a few plants, for example, three plants, four plants, five plants, eight plants, or more (or less), etc. In this embodiment, each plant is associated with a specific image, in which the plant is generally centered. As such, again, while a segment or sub-image from step 316 may include multiple plants, one of the plants is centered or featured in the image.

With reference still to FIG. 3, the computing device 102 then assigns metadata to the images and stores the data, at 318, and loads the trained model(s) from the data structure 104, at 321. At 322, the computing device 102 then classifies (e.g., in the manner generally described above in the system 100, etc.) each of the plants included in the image data (e.g., represented by the images, the sub-images, etc.) for the field 106 (as processed from steps 304-318). For example, the computing device 102 may classify each of the plants as rogue or non-rogue.

Optionally, the computing device 102 may generate, at 324, one or more metrics for the plants identified/classified as rogue plants, if any. The computing device 102 may determine a number of rogue plants per row, per field, per acre, etc., and also determine whether any one or more of the metrics satisfies or violates one or more defined thresholds. For example, the computing device 102 may determine that the number of classified rogue plants per acre for the field 106 violates a purity thresholds, whereby a warning or flag is generated.

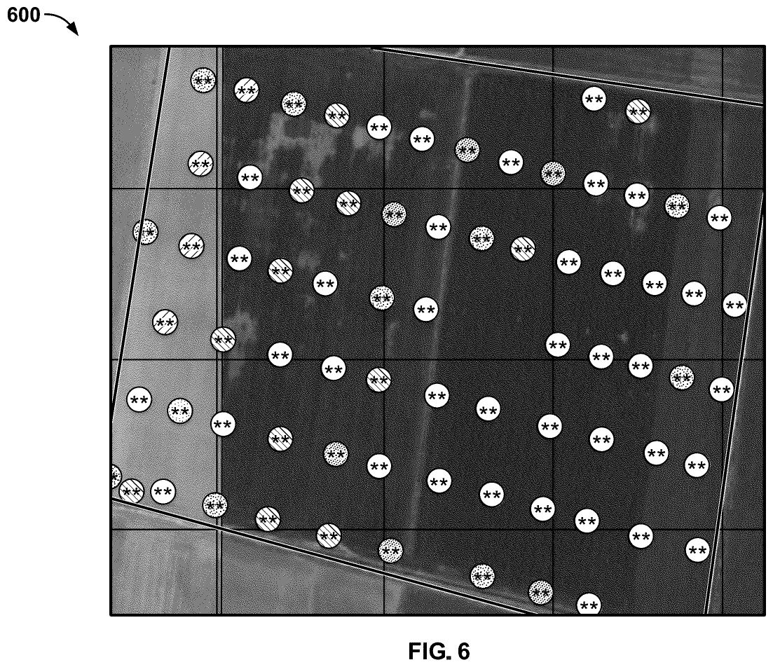

Regardless of the generation of metrics, the computing device 102 generates an output map, in this example embodiment, which includes a data definition and/or a visual definition of the rogue plants in the field 106. FIG. 6, for example, illustrates such a visual map 600 of the field 106, with each classified or identified rogue plant included therein. In FIG. 6, for example, each color/pattern indicates a bucketed histogram color/pattern scale for a number of rogue plants present in each image. For instance, circles provided in a red color, or hatched pattern, or dotted pattern may represent more rogue plants than those provided in a white color (or non-hatched pattern), etc. In addition, numerical values may be associated with each of the classified plant/location, for example, on a scale of 0-10, where the higher number may be more indicative of a rogue plant, etc. Within the images themselves, each rogue plant may also have its own annotation, for instance, an “x” or the rogue being circled to identify the exact plant that was rogue from surrounding material. Further to the above, in some example embodiments, the computing device 102 may generate an output map providing a visual definition of the rogue plants that have been removed by a removal system, etc.

Finally in the method 300, based on the output map, an agricultural implement (e.g., as part of a rogue removal system, etc.) may be operated (e.g., automatically based on coordinates of the rogue plants included in the output map, etc.) to locations of the rogue plants in the field 106 and then used to remove the rogue plants (e.g., pull, harvest, spray, otherwise destroy, etc.). For example, the capture device 110 may identify a rogue plant in the field 106 as it traverses the field 106 and, in real time as the plant is identified, also remove (or cause removal of) the rogue plant from the field 106. In doing so, a removal device coupled to the capture device 110 or traveling in communication with the capture device 110b may remove the rogue plant. The removal device may mechanically remove the identified rogue plant (e.g., pull, disable, destroy, neutralize, cut, chop, strike the plant with blade, etc.), chemically inject or spray the plant such that the plant dies in place in the field 106, laser cut the plant, water or air jet cut the plant, electrify and/or burn the plant (e.g., via nitrogen or a flame, etc.). That said, it should be appreciated that the removal device may travel along the ground to remove ethe rogue plants or it may include an aerial device that moves through the air.

In view of the above, the systems and methods herein may provide for identifying rogue plants in growing spaces based on image analysis associated with the growing spaces. In connection therewith, the systems and methods herein may provide an objective measure of identifying rogue plants in a significant number of growing spaces is provided, which eliminates need for manual intervention, etc. For instance, in various embodiments, the systems and methods herein may provide increased coverage of growing spaces for analysis by at least about 300% or more, for example, as compared to manual intervention. In some embodiments, an image as captured herein may cover between about 500 square feet and about 2,000 square feet. As such, in some examples, at least about 120 acres per day may be covered, at least about two fields (or more, depending on sizes of the fields) may be covered, etc. by a capture device herein (e.g., by a UAV having a flight time of between about 0.5 hours and about 1 hour, by a ground vehicle moving at between about 4 mph and about 7 mph covering about 6 rows, etc.). In addition, based on the above, the systems and methods herein provided for one or more corrective actions, based on the identified rogue plants, whereby the at least a portion of the rogue plants are removed or otherwise struck at the growing spaces and a purity of the crop(s) in the growing spaces is maintained and/or decontamination of the growing spaces (and products therefrom) is promoted and/or ensured. In this manner, the systems and methods herein provide an automated, objective measure of identifying rogue plants in a significant number of growing spaces. In addition, in some embodiments, the systems and methods herein provide automated actions to address (e.g., strike, etc.) the identified rogue plants (e.g., to remove the identified rogue plants from the growing spaces, to kill the identified rogue plants in the growing spaces, to inhibit further growth of the rogue plants in the growing spaces, etc.).

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing data specific to an agricultural field, the data including an image of the field captured, by at least one capture device, during a particular growth stage of a crop in the field, the crop defining multiple rows within the field; (b) detecting the multiple rows of the field in the image; (c) based on the detected multiple rows in the field, separating the image of the field into multiple sub-images, each sub-image including multiple plants in at least one row of the field; (d) applying a trained classifier model to the sub-images from the image and classifying, using the trained classifier model, each of the multiple plants included in the sub-images as a rogue plant or as not a rogue plant; and/or (e) generating an output map of at least the classified rogue plants in the agricultural field, the output map indicative of a location of the rogue plants in the agricultural field.

The above-described embodiments of the disclosure may also be implemented using computer programming or engineering techniques, including computer software, firmware, hardware or any combination or subset thereof, wherein the technical effect may be achieved by performing at least one of the following operations: (a) accessing data specific to an agricultural field, the data including an image of the field captured, by at least one capture device, during a particular growth stage of a crop in the field; (b) identifying at least one plant included in the image; (c) applying a trained classifier model to the image and classifying, using the trained classifier model, the at least one plant included in the image as a rogue plant or as not a rogue plant; (d) in response to the at least one plant included in the image being classified as a rogue plant, striking the at least one plant from the agricultural field at about the same time the at least one plant is classified as a rogue plant and/or the image of the field is captured by the at least one capture device; and/or (e) in response to the at least one plant included in the image being classified as a rogue plant, generating an output map for in the agricultural field, the output map indicative of a location of the at least one plant classified as a rogue plant.

The above-described embodiments of the disclosure may also be implemented using computer programming or engineering techniques, including computer software, firmware, hardware or any combination or subset thereof, wherein the technical effect may be achieved by performing at least one of the following operations: (a) accessing, by a computing device, data specific to an agricultural field, the data including an image of the field captured, by at least one capture device, during a particular growth stage of a crop in the field; (b) separating, by the computing device, the image of the field into multiple sub-images, each sub-image including multiple plants; (c) applying, by the computing device, a trained classifier model to the sub-images from the image and classifying, using the trained classifier model, each of the multiple plants included in the sub-images as a rogue plant or as not a rogue plant; and/or (d) generating an output map of at least the classified rogue plants in the agricultural field, the output map indicative of a location of the rogue plants in the agricultural field.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if

Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying rogue plants in an agricultural field, the method comprising:
accessing, by a computing device, data specific to an agricultural field, the data including an image of the field captured, by at least one capture device, during a particular growth stage of a crop in the field;
identifying at least one plant included in the image;
applying, by the computing device, a trained classifier model to the image and classifying, using the trained classifier model, the at least one plant included in the image as a rogue plant or as not a rogue plant; and
in response to the at least one plant included in the image being classified as a rogue plant, generating an output map for the agricultural field, the output map indicative of a location of the at least one plant classified as a rogue plant.

2. The computer-implemented method of claim 1, wherein the image includes multiple images, including at least one image of a leaf instance and at least one image of a stalk instance; and
wherein applying the trained classifier model to the image includes:
determining, by the computing device, multiple measurements from the multiple images; and
classifying the at least one plant, as a rogue plant or not a rogue plant, based on the determined measurements of the multiple images.

3. The computer-implemented method of claim 2, wherein the at least one image of the stalk instance also includes a brace root instance.

4. The computer-implemented method of claim 1, wherein the crop includes corn; and/or
wherein the at least one capture device includes an unmanned aerial vehicle (UAV) and/or a ground vehicle.

5. The computer-implemented method of claim 1, further comprising, in response to the at least one plant included in the image being classified as a rogue plant, striking the at least one plant from the agricultural field at about the same time the at least one plant is classified as a rogue plant and/or the image of the field is captured by the at least one capture device.

6. The computer-implemented method of claim 1, wherein the trained classifier model includes one or more of: a RTMDet instance segmentation deep learning model, a generative adversarial network, an autoencoder network, and an instance segmentation network.

7. The computer-implemented method of claim 6, further comprising formatting the accessed data, prior to identifying at least one plant included in the image.

8. The computer-implemented method of claim 1, further comprising:
applying, by the computing device, a shape file to the image, the shape file including a grid;
cropping, by the computing device, the image based on the grid; and
detecting the at least one row of the field in the cropped image.

9. The computer-implemented method of claim 1, further comprising generating at least one metric based on the at least one rogue plant, the output map including the at least one metric; and
wherein the at least one rogue plant includes multiple rogue plants, and wherein the at least one metric includes a number of the multiple rogue plants in the image or a number of rogue plants per acre of the agricultural field.

10. The computer-implemented method of claim 9, wherein the output map includes a visual output map, in which the at least one plant is positioned in a map of the field based on the location of said at least one plant and in which the at least one plant is illustrated as a rogue plant.

11. A computer-implemented method for use in identifying rogue plants in an agricultural field, the method comprising:
accessing, by a computing device, data specific to an agricultural field, the data including an image of the field captured, by at least one capture device, during a particular growth stage of a crop in the field;
identifying at least one plant included in the image;
applying, by the computing device, a trained classifier model to the image and classifying, using the trained classifier model, the at least one plant included in the image as a rogue plant or as not a rogue plant; and
in response to the at least one plant included in the image being classified as a rogue plant, striking the at least one plant from the agricultural field at about the same time the at least one plant is classified as a rogue plant and/or the image of the field is captured by the at least one capture device.

12. The computer-implemented method of claim 11, further comprising generating an output map identifying a location of the at least one plant in the agricultural field and identifying the at least one plant as a rogue plant.

13. A computer-implemented method for use in identifying rogue plants in an agricultural field, the method comprising:
accessing, by a computing device, data specific to an agricultural field, the data including an image of the field captured, by at least one capture device, during a particular growth stage of a crop in the field;
separating, by the computing device, the image of the field into multiple sub-images, each sub-image including multiple plants;
applying, by the computing device, a trained classifier model to the sub-images from the image and classifying, using the trained classifier model, each of the multiple plants included in the sub-images as a rogue plant or as not a rogue plant; and
generating an output map of at least the classified rogue plants in the agricultural field, the output map indicative of a location of the rogue plants in the agricultural field.

14. The computer-implemented method of claim 13, wherein the crop includes corn; and/or
wherein the at least one capture device includes an unmanned aerial vehicle (UAV) and/or a ground vehicle; and/or
wherein the growth stage includes at least one growth stage between growth stage V1 and growth stage VT or between growth stage R1 and growth stage R6.

15. The computer-implemented method of claim 13, wherein the trained classifier model includes one or more of: a statistical classification model, a generative adversarial model, an autoencoder model, and an instance segmentation model.

16. The computer-implemented method of claim 13, further comprising:
formatting the accessed data
detecting, by the computing device, based on the formatted accessed data, multiple rows of the field including the multiple plants in the image; and
wherein separating, by the computing device, the image of the field into multiple sub-images includes separating, by the computing device, the image of the field into multiple sub-images based on the detected multiple rows in the field.

17. The computer-implemented method of claim 13, further comprising:
applying, by the computing device, a shape file to the image, the shape file including a grid; and
cropping, by the computing device, the image based on the grid; and
wherein detecting the multiple rows of the field in the image includes detecting the multiple rows of the field in the cropped image.

18. The computer-implemented method of claim 13, further comprising striking, by an agricultural implement, the rogue plants from the field.

19. The computer-implemented method of claim 13, wherein the output map includes a visual, geospatial output map, in which each of the rogue plants is positioned in a map of the field based on the location of said rogue plant.

20. A system for use in identifying rogue plants in an agricultural field, the system comprising at least one computing device configured to:
access data specific to an agricultural field, the data including an image of the field captured, by at least one capture device, during a particular growth stage of a crop in the field;
identify at least one plant included in the image of the field in at least one row of the field;
apply at least one classifier model to the image to classify, using the at least one classifier model, the at least one plant included in the image as a rogue plant or as not a rogue plant; and
generate an output map of the at least one plant in the agricultural field, the output map indicative of a location of the at least one plant and an indication of the at least one plant as a rogue plant or as not a rogue plant.

21. The system of claim 20, further comprising an automated apparatus configured to strike the at least one plant from the agricultural field, based on classification of the at least one plant as a rogue plant, at about the same time the image of the field is captured by the at least one capture device.
